(19) United States
(12) Patent Application Publication
(10) Pub. No.: US 2025/0039538 A1
(43) Pub. Date: Jan. 30, 2025

(54) USAGE INCLINED SCENE STATISTICS SELECTION

(71) Applicant: QUALCOMM Incorporated, San Diego, CA (US)

(72) Inventors: Mamta Pankaj BHARADIYA, Hyderabad (IN); Daksha Gouri PATOLIA, Hyderabad (IN); Shubhobrata DUTTA CHOUDHURY, New Delhi (IN); Sai Krishna BODAPATI, Vijaywada (IN)

(21) Appl. No.: 18/353,813

(22) Filed: Jul. 17, 2023

(51) Int. Cl. H04N 23/63; H04N 23/61; H04N 23/62

(52) U.S. Cl. CPC H04N 23/635; H04N 23/61; H04N 23/62

(57) ABSTRACT

Aspects presented herein may enable personalization of camera statistics selection algorithm based on each user and the user's tendencies/pattern in camera usage. In one aspect, a user equipment (UE) (e.g., a camera or a device equipped with at least one camera) selects a set of patterns associated with one or more regions of interest (ROIs) from a set of images. The UE identifies, based on the selected set of patterns, one or more relevant objects in a field of view (FOV) of a camera, where the FOV of the camera is associated with the one or more ROIs. The base station outputs an indication of the one or more relevant objects in the FOV of the camera.

### TECHNICAL FIELD

The present disclosure relates generally to image processing, and more particularly, to image processing involving scene/statistics selection based on user usage.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus selects a set of patterns associated with one or more regions of interest (ROIs) from a set of images. The apparatus identifies, based on the selected set of patterns, one or more relevant objects in a field of view (FOV) of a camera, where the FOV of the camera is associated with the one or more ROIs. The apparatus outputs an indication of the one or more relevant objects in the FOV of the camera.

In an aspect of the disclosure, a method, a computer-readable medium, and an apparatus are provided. The apparatus records a set of camera modes associated with one or more scenes selected by a user. The apparatus identifies, based on the recorded set of camera modes, a camera mode or a set of parameters to be applied to a camera under a specific scene. The apparatus outputs an indication of the camera mode or the set of parameters to be applied to the camera under the specific scene.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a camera (or an artificial intelligence (AI) or machine learning (ML) (AI/ML) module associated with the camera) trained to identify a saliency in the field of view (FOV) of the camera in accordance with various aspects of the present disclosure.

FIG. 5 is a diagram illustrating an example of training an AI/ML module to identify one or more patterns/features based on a past usage of a user in accordance with various aspects of the present disclosure.

FIG. 6 is a diagram illustrating an example of an AI/ML module identifying one or more patterns/features based on a past usage of a user in accordance with various aspects of the present disclosure.

FIG. 7 is a diagram illustrating an example of training an AI/ML module to identify one or more patterns/features based on a past usage of a user in accordance with various aspects of the present disclosure.

FIG. 8 is a flowchart illustrating an example of a scene statistics selection based on the past usage of a user in accordance with various aspects of the present disclosure.

FIG. 9 is a flowchart illustrating an example of a camera mode selection based on the past usage of a user in accordance with various aspects of the present disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a diagram illustrating an example of a hardware implementation for an example apparatus and/or network entity.

### DETAILED DESCRIPTION

Aspects presented herein may improve performance and user experience associated with photo taking by enabling a camera (including a device equipped with at least one camera) to provide scene statistics selection(s) (e.g., selection(s) of camera statistics for one or more scenes) for a user based on the usage (e.g., historical/past usage) of the user, which may be referred to as a usage inclined scene statistics selection for purposes of the present disclosure. In one aspect of the present disclosure, an AI/ML algorithm/module may be configured/trained to perform user learning to pick relevant objects (e.g., region of interests (ROIs)) based a user's usage or pattern of use for statistics processing and post processing. For purposes of the present disclosure, an ROI may refer to a set of pixel locations on an image that is associated with a specified feature or thing (e.g., an object, a specie, a location, a subject, etc.). In another aspect of the present disclosure, an artificial intelligence (AI) or machine learning (ML) (AI/ML) algorithm/module may be configured/trained to perform use case learning to pick relevant capture modes for a user.

Aspects presented herein may enable personalization of camera statistics selection algorithm based on each user and the user's tendencies/pattern in camera usage. For example, the camera may use a deep learning (DL) model that uses user's past captures (e.g., from online photos/cloud services/phone gallery, etc.) as a training base to extract relevant ROI in common field of views (FOVs), and act on top of the general saliency which may be part of a common/general implementation. Aspects presented herein may enable better image outputs with minimal to zero user involvement. Aspects presented herein may use reinforcement learning on top of clustering and classification to learn which modes (e.g., camera mode) are most probable in any given camera use case.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

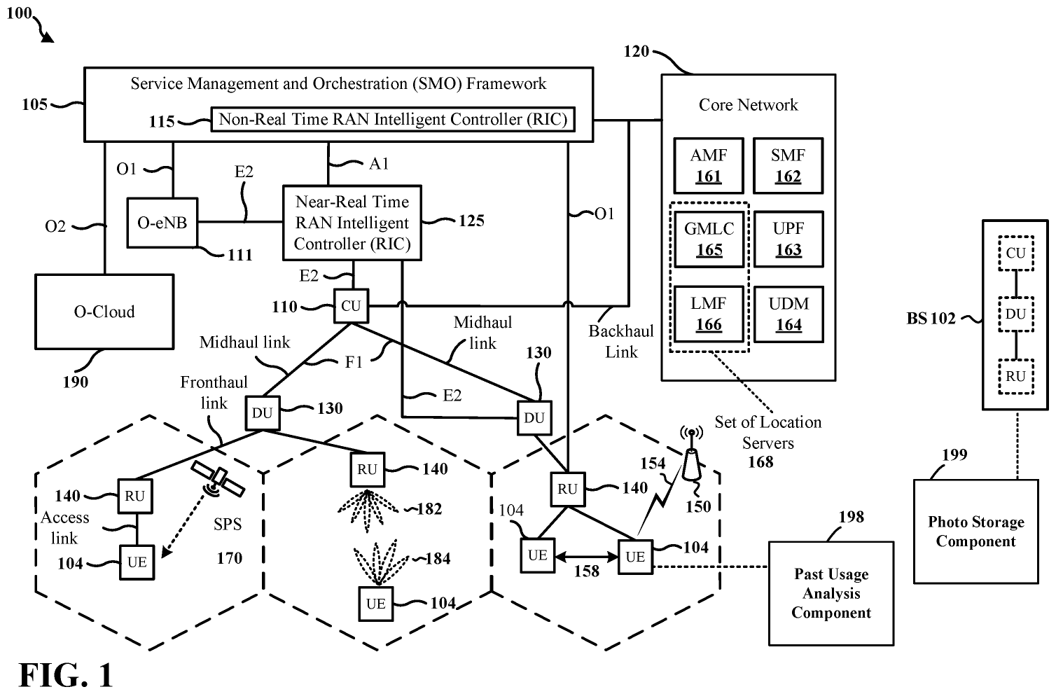

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as Al policies).

At least one of the CU 110, the DU 130, and the RU 140 may be referred to as a base station 102. Accordingly, a base station 102 may include one or more of the CU 110. the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a past usage analysis component 198 that may be configured to select a set of patterns associated with one or more ROIs from a set of images; identify, based on the selected set of patterns, one or more relevant objects in an FOV of a camera, where the FOV of the camera is associated with the one or more ROIs; and output an indication of the one or more relevant objects in the FOV of the camera. In certain expects, the past usage analysis component 198 may be configured to record a set of camera modes associated with one or more scenes selected by a user; identify, based on the recorded set of camera modes, a camera mode or a set of parameters to be applied to a camera under a specific scene; and output an indication of the camera mode or the set of parameters to be applied to the camera under the specific scene. In certain aspects, the base station 102 may include a photo storage component 199 that may be configured to receive images transmitted from the UE 104 and store the images in a server.

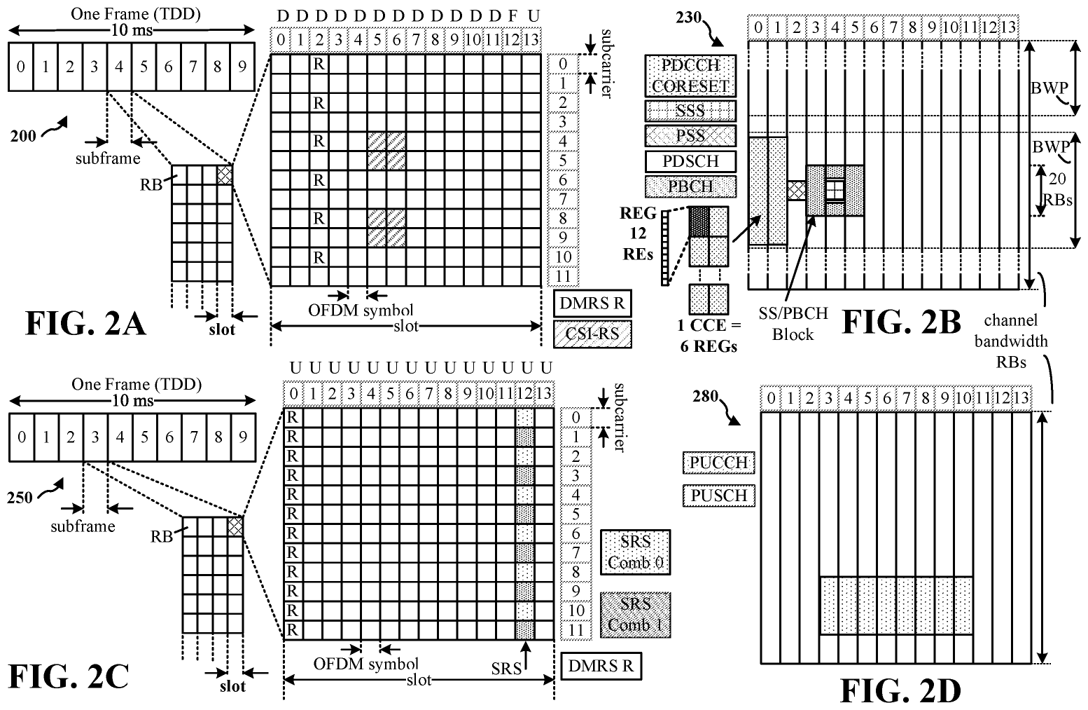

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | $SCS Δ f = {2}^{μ} \cdot 15 [ kHz ]$ | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

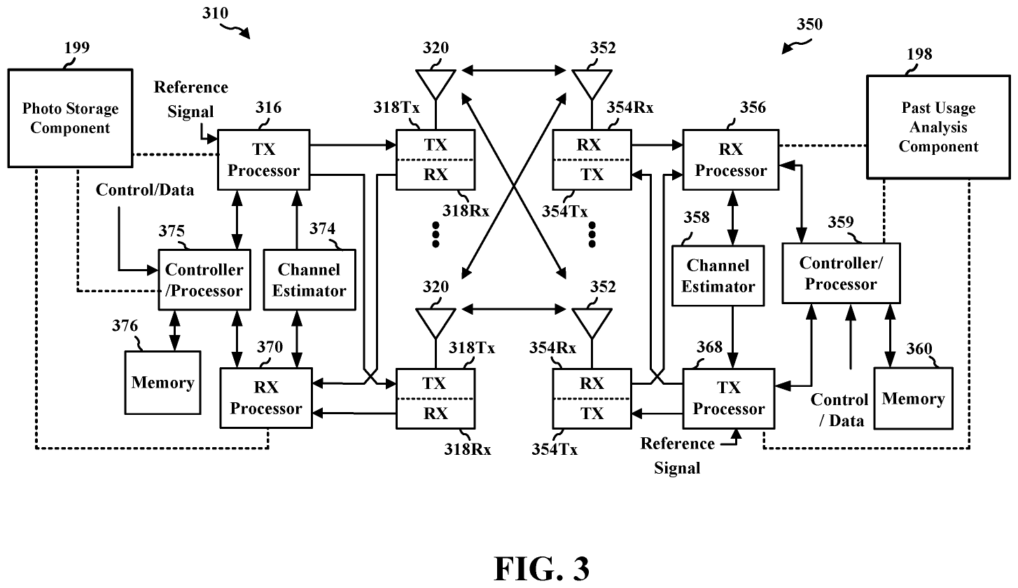

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the past usage analysis component 198 of FIG. 1.

At least one of the TX processor 316, the RX processor 370, and the controller/processor 375 may be configured to perform aspects in connection with the photo storage component 199 of FIG. 1.

The generalization of cameras has grown significantly over the years, fueled by advancements in technology and the increasing accessibility of photography. Cameras have become ubiquitous in today's world, with a wide range of devices (e.g., mobile electronics, vehicles, cell towers, etc.) using camera(s) to improve their performances. For example, cameras have been used by positioning devices to enhance the accuracy of positioning, used by wireless devices for improving communication quality, and/or used by vehicles for enhancing road safety, etc. In addition, as smartphones have been built with higher quality cameras and more advance functions, these built-in cameras and functions have improved photography in terms of resolution, image quality, and features.

Various types of artificial intelligence (AI)/machine learning (ML) (AI/ML) mechanisms/modules (which may include deep learning AI/ML models) have been developed and implemented to improve cameras and photography. For example, certain ML/AI algorithms may be used by cameras (or devices equipped with at least one camera) to automatically enhance images captured by cameras by adjusting camera-related parameters, such as brightness, contrast, and/or color balance of the captured images. These ML/AI algorithms may analyze large datasets of photos to learn and replicate the editing techniques used by experts, resulting in better-looking images with minimal effort. In another example, image recognition related AI/ML algorithms may be used by cameras for identifying specified objects/subjects (e.g., human, animal, etc.) and/or scenes in real-time. This may enable cameras to automatically focus on specified subject or scene, track moving objects, and adjust settings accordingly. As such, various AI/ML models (e.g., deep learning models) may have the capability to locate (e.g., find out) one or more “relevant objects” in the field of view (FOV) of a camera. For purposes of the present disclosure, a relevant object, which may also be called as a “primary region of interest (ROI), may refer to an output of an AI/ML model (e.g., a DL engine) for a given FOV. For aspects described herein, a relevant object or a primary ROI may refer to an object that is primarily being focus on given a history of photography/videography. For example, the history of the photography and learnings from them may be referred to as “gallery learnings.” For example, amongst a crowd, an owner of a phone or any known people (from gallery learnings) may form the “primary ROI” or the “relevant object.” In another example, in a park with many dogs and other pets, a specified dog (from gallery learnings) may form the primary ROI″ or the “relevant object.” In another example, in a park or a garden with many trees, a tree with most colorful flowers (from gallery learnings) may form the primary ROI″ or the “relevant object,” etc. In some implementations, the one or more relevant objects located by the AI/ML algorithms may also be used by the camera for setting appropriate/suitable camera statistics (stats) as well as setting post processing pre-tones. Camera statistics may include exposure, white balance, and/or focus, etc., and post processing pre-tones may include noise reduction, color enhancements, and/or other forms of tuning, etc. For example, after an AI/ML algorithm identifies a human face in the FOV of a camera, the AI/ML algorithm may apply color settings.

In the context of a camera's FOV, “saliency” may refer to the visual attention or importance assigned to different regions or objects within a captured image/scene, which may involve identifying the most visually significant or relevant areas that draw attention and stand out from the rest of the image. In some implementations, saliency in a camera's FOV may be determined by various factors, including color contrast, motion, edges, and/or object recognition, etc. Saliency may be a subjective aspect which is personal to every user and to every camera use case. While at a general expectation level, AI/ML algorithms may have the capability to find saliency in the FOV of a camera, the performance of finding the saliency may be optimal just in situations similar to those on which these AI/ML algorithms were trained.

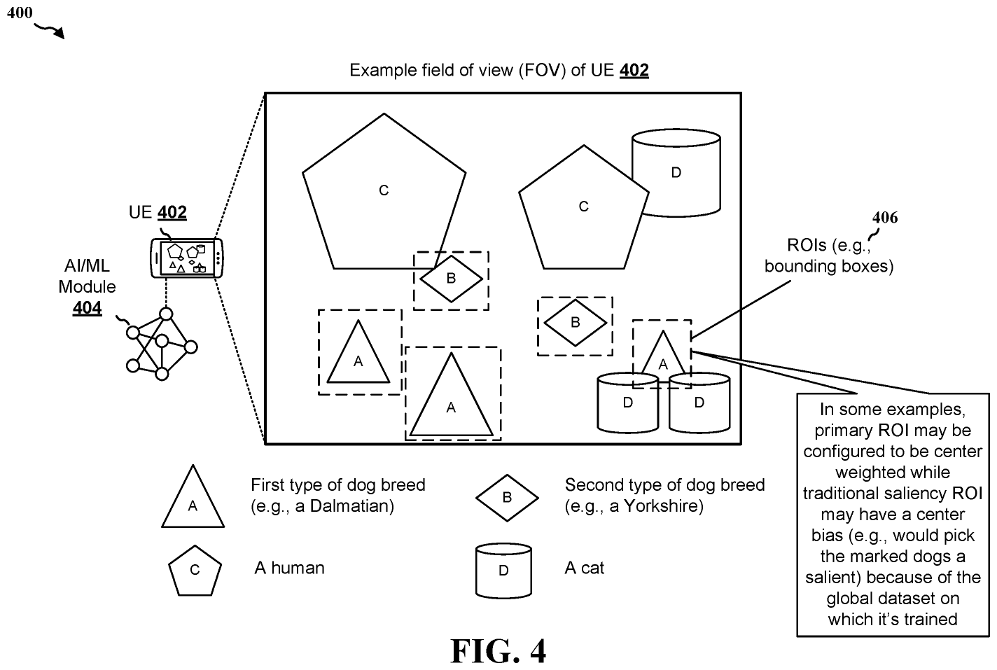

FIG. 4 is a diagram 400 illustrating an example of a camera (or an AI/ML module associated with the camera) trained to identify a saliency in the FOV of the camera in accordance with various aspects of the present disclosure. An AI/ML module 404 associated with a camera or a device equipped with at least one camera (collectively as a “UE 402”) may be trained to identify dogs in the FOV of the UE 402 and apply appropriate camera settings (e.g., color adjustments, brightness adjustments, etc.) for the identified dogs. For example, as shown at 406, when the FOV of the UE 402 includes a plurality of objects, such as a first type of dog breed (e.g., a Dalmatian), a second type of dog breed (e.g., a Yorkshire), humans, and cats, the AI/ML module 404 may identify the region of interests (ROIs) associated with dogs (e.g., Dalmatian and Yorkshire), such as by displaying a bounding box around them.

In some scenarios, if the AI/ML module 404 is trained with a database that includes more of a specific breed of dog (e.g., Yorkshire terriers), the identification of dogs and the application of camera settings are likely to be optimal for that specific breed of dog (e.g., the Yorkshire terriers) compared to other breeds of dogs (e.g., Dalmatians, French bulldogs, etc.). In another example, the AI/ML module 404 may be trained to focus on identifying humans when a party scene is detected and apply appropriate camera settings for the humans. However, the AI/ML module 404 may not be suitable for a user who just want to capture or focus on decorations used in the party scene.

Aspects presented herein may improve performance and user experience associated with photo taking by enabling a camera (including a device equipped with at least one camera) to provide scene statistics selection(s) (e.g., selection(s) of camera statistics for one or more scenes) for a user based on the usage (e.g., historical/past usage) of the user, which may be referred to as a usage inclined scene statistics selection for purposes of the present disclosure. In one aspect of the present disclosure, an AI/ML algorithm/module may be configured/trained to perform user learning to pick relevant objects (e.g., region of interests (ROIs)) based a user's usage or pattern of use for statistics processing and post processing. For purposes of the present disclosure, an ROI may refer to a set of pixel locations on an image that is associated with a specified thing of feature (e.g., an object, a specie, a location, a subject, etc.). In another aspect of the present disclosure, an AI/ML algorithm/module may be configured/trained to perform use case learning to pick relevant capture modes for a user.

In one aspect of the present disclosure, at least one AI/ML module associated with user learning may be added to a camera (or a device equipped with at least one camera) to alter statistics selection performed by the camera based on an output confidence. In some implementations, the one or more modules may be added on an existing camera statistics framework associated with the camera. For example, the at least one AI/ML module may be in the form of a deep learning model which is capable of learning statistics selection based on a user's past image capturing behaviors, which may be obtained/accessed from a cloud server/image gallery, and/or from an in-house photo gallery (e.g., a medium/memory attached to the camera that stores images captured by the camera).

For example, the at least one AI/ML module may be configured to determine/identify one or more patterns (e.g., ROIs, image patterns, close patterns, etc.) based on types of images captured by the user, which may be clustered into groups (e.g., images with pets, images with outdoor environments, images associated with a gym, images displaying parties, etc.). For purposes of the present disclosure, a cluster may refer to a group of images under a common theme. Ins some scenarios, this theme may also be an output of an AI/ML model/module. The AI/ML model/module specified for this may be trained for the act of clustering itself, which means it is trained to output an overall theme of the input FOV based on its training. Each group (or each cluster) may be evaluated by the at least one AI/ML module for generalization of a “camera intent,” which may refer to what was intended to be captured and under what scenarios for purposes of the present disclosure. For examples, a group/cluster of pet images may be evaluated by the at least one AI/ML module, and the at least one AI/ML module may determine that the camera intent for these images are focusing on dogs in a park (e.g., most images display dogs playing on a green/grass field).

Then, this data (e.g., the clustering/grouping of images and determination of corresponding camera intent) may be used for training the at least one AI/ML module (or another AI/ML module, such as a master deep learning model) to select one or more relevant/specified objects/subjects in the FOV of the camera based on the past usage of the user. For example, when the user is trying to capture an image using the camera, the camera may prioritize the identification of dogs (rather than human or other objects) when both dog and park/green field are detected in the FOV of the camera.

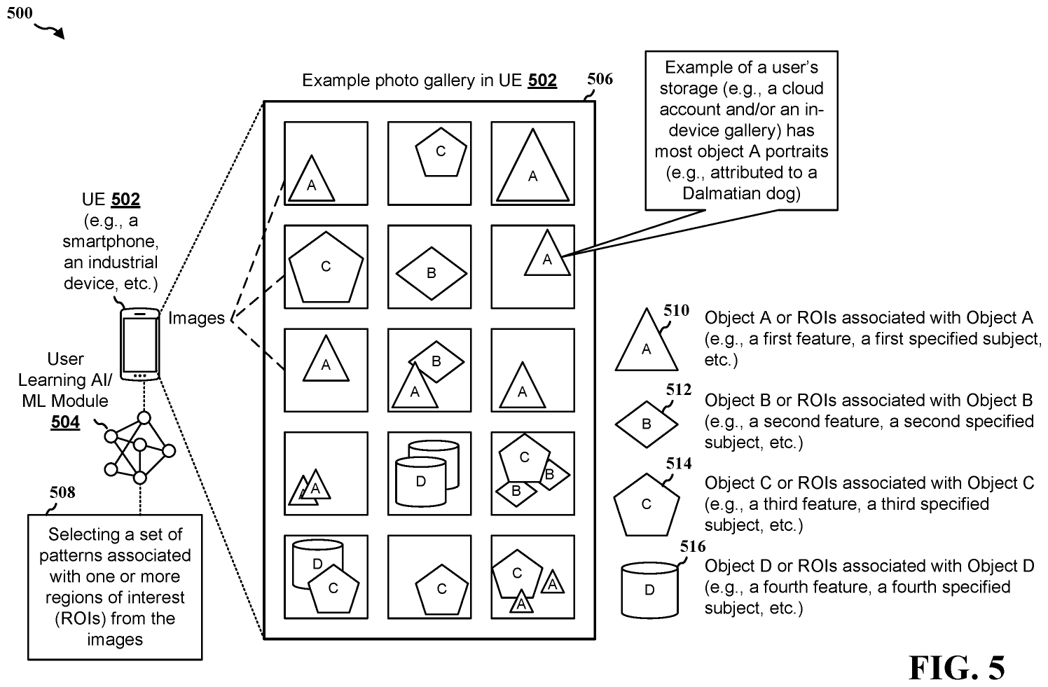

FIG. 5 is a diagram 500 illustrating an example of training an AI/ML module to identify one or more patterns/features based on a past usage of a user in accordance with various aspects of the present disclosure. A camera or a device equipped with at least one camera such as a smartphone or an industrial device with at least one camera (collectively as a “UE 502”) may be associated with (e.g., include) at least one user learning AI/ML module 504. As shown at 506, the UE 502 may have access to a photo gallery that includes a set of images captured by the UE 502, where the photo gallery (or the set of images) may be stored at a cloud server or in the memory of the UE 502. For purposes of the present disclosure, images may also include a set of frames (e.g., video images) of a video.

In one example, as shown at 508, the user learning AI/ML module 504 may be configured to identify/select a set of patterns associated with one or more ROIs from the images in the photo gallery. For example, the images may include a plurality of object A 510 (e.g., a Dalmatian dog) or ROIs associated with the object A 510, a plurality of object B 512 (e.g., a Yorkshire dog) or ROIs associated with the object B 512, a plurality of object C 514 (e.g., humans) or ROIs associated with the object C 514, and a plurality of object D 516 (e.g., cats) or ROIs associated with the object D 516, etc. The user learning AI/ML module 504 may cluster these images into multiple groups (e.g., image groups). For example, images with animals may be clustered into a first group, images with humans may be clustered into a second group, images with outdoor environments may be clustered into a third group, etc. In some examples, an image with multiple objects may be clustered into multiple groups, just one of the groups, and/or none of the groups depending on the implementations.

Based on the clustering of the images, the user learning AI/ML module 504 may identify/select a set of patterns associated with each image group. For example, as shown at 506, if the first group includes mostly object A 510, which may be attributed to a Dalmatian dog (e.g., the number of object A 510 is more prominent in the group compared to other objects (e.g., objects C, B, and/or D)), the user learning AI/ML module 504 may associate object A 510 or feature(s) of the object A 510 with the first group. The user learning AI/ML module 504 may then use this information to set primary scene statistics in a scene (e.g., in the FOV of the UE 502).

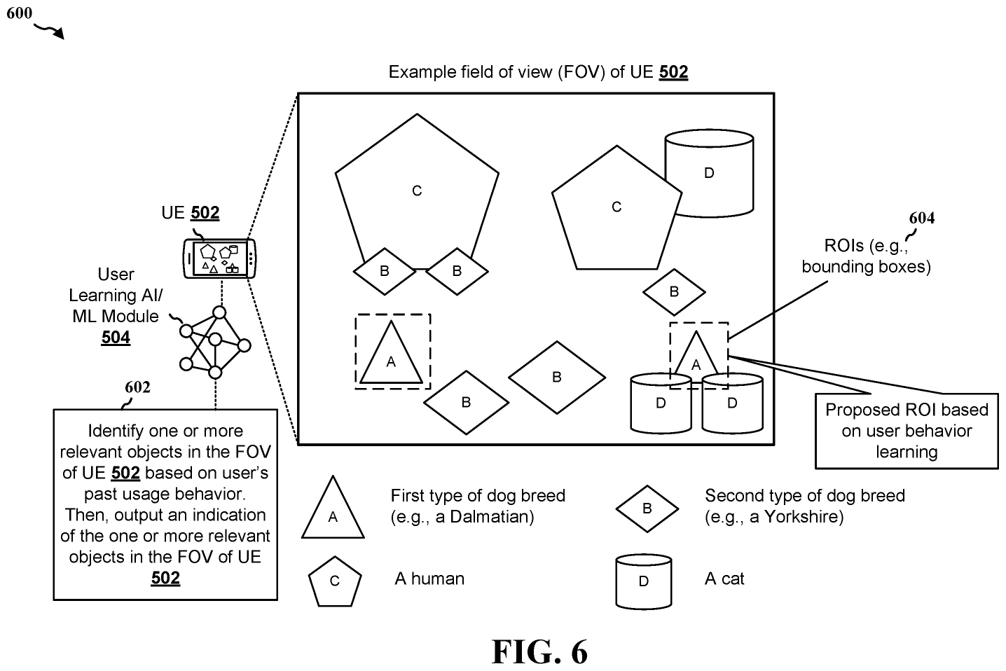

FIG. 6 is a diagram 600 illustrating an example of an AI/ML module identifying one or more patterns/features based on a past usage of a user in accordance with various aspects of the present disclosure. As shown at 602, information that indicates Dalmatian dog(s) appears most often in the photo gallery of the UE 502 (as described in connection with FIG. 5) may be used to set primary scene statistics in a scene that includes a Dalmatian dog. For example, as shown at 604, when the FOV of the UE 502 includes a plurality of objects, such as a first type of dog breed (e.g., a Dalmatian), a second type of dog breed (e.g., a Yorkshire), humans, and cats, the UE 502 (or the at least one user learning AI/ML module 504) may identify the ROIs associated with Dalmatians (e.g., and excluding Yorkshires), such as by displaying a bounding box around Dalmatians. Then, the UE 502 (or the at least one user learning AI/ML module 504) may apply suitable/appropriate scene states for these identified ROIs (or for the whole FOV/image based on these ROIs) regardless if there are even more prominent animals (e.g., Yorkshires) in the scene, which may have otherwise been picked by an existing statistics algorithms as described in connection with FIG. 4.

In some examples, the UE 502 (or the at least one user learning AI/ML module 504) may also output the indication of the one or more relevant objects in the FOV to another module or entity. For example, the UE 502 (or the at least one user learning AI/ML module 504) may consume (e.g., use, apply, etc.) the indication of the one or more relevant objects, store the indication of the one or more relevant objects, and/or transmit the indication of the one or more relevant objects.

In another example, the UE 502 may be configured to determine whether the at least one user learning AI/ML module 504 is capable of identifying the one or more relevant objects in the FOV of the UE 502 with a confidence level exceeding a confidence threshold. Then, the UE 502 may deploy the at least one user learning AI/ML module 504 for identifying the one or more relevant objects in the FOV of the UE 502 if the at least one user learning AI/ML module 504 has the confidence level exceeding the confidence threshold. If the at least one user learning AI/ML module 504 does not have the confidence level exceeding the confidence threshold, then the UE 502 may be configured to deploy an existing AI/ML model for identifying the one or more relevant objects in the FOV of the UE 502 (discussed more in details below).

In another example, a set of images captured by a camera (e.g., the UE 502) may include classroom snapshots of the whiteboard and teacher. In this example, the camera may be trained to derive statistics from the whiteboard/teacher by default regardless of the activity in foreground (e.g., from other classmates or objects, etc.). As such, aspects presented herein may enable camera scene statistics selection that is based on the past behavior of the user, thereby providing the users with an improved user experience in photography.

In another aspect of the present disclosure, apart from learning a user's past image capturing behaviors for determining/selecting suitable/appropriate scene statistics, an AI/ML module may also be configured to learn a user's behavior with respect to one or more scenes for appropriate mode selection(s) (e.g., camera mode selection(s)). For example, an AI/ML module may be configured to learn that a user is more likely to take a selfie (e.g., using a front camera on the screen side of a mobile phone instead of the camera on the other/rear side of the mobile phone) when a scene (e.g., an environment or an area in the FOV of the camera) includes a specified set of objects (e.g., the user like to take selfies with sunflowers). Thus, when the AI/ML module detects a scene that includes similar specified set of objects (e.g., an environment full of sunflowers) when the user activates or is using the camera function (e.g., selecting/clicking a camera application, under camera mode, etc.), the AI/ML module may activate/trigger the camera to enter into the selfie mode instead of a standard/default mode (e.g., using the front camera instead of a default mode that uses the rear camera).

In some examples, the AI/ML module may be in the form of a reinforcement learning model (e.g., starting off from existing capture data from cloud server/local photo gallery, etc.) which learns from the mode corrections and/or changes that the user makes based on the scene. Similarly, each scene may be clustered into categories (e.g., such as parties, landscapes, sports, etc.) and the linked use case (e.g., portrait mode, selfie mode, video mode, filters, tele zoom, etc.) may be identified in a database. Thus, this database may also be constructed on the user's past usage data and preferences, while also getting trained on the go based on each usage (e.g., based on manual input(s)). Then, each subsequent usage may be used to train the probabilities among these scene-usage linkages, where the camera may be configured to pick the usage with highest probability for the given scene (discussed in details below).

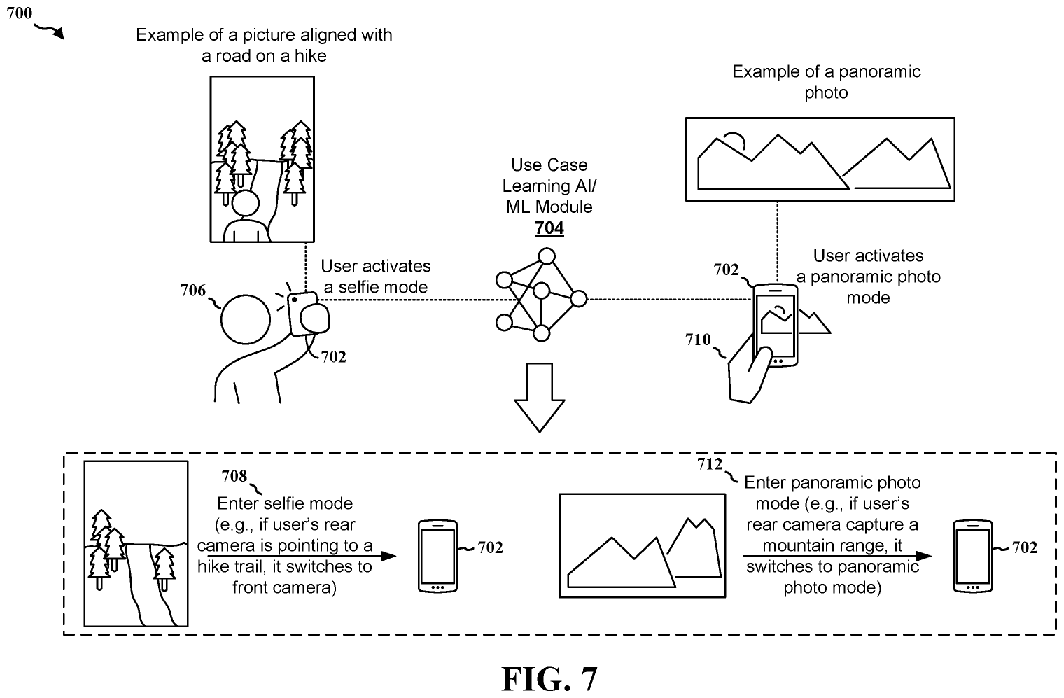

FIG. 7 is a diagram 700 illustrating an example of training an AI/ML module to identify one or more patterns/features based on a past usage of a user in accordance with various aspects of the present disclosure. A camera or a device equipped with at least one camera such as a smartphone or an industrial device with at least one camera (collectively as a “UE 702”) may be associated with (e.g., include) at least one use case learning AI/ML module 704 (e.g., a reinforcement learning model). For purposes of the present disclosure, images may also include a set of frames (e.g., video images) of a video.

In one example, as shown at 706, a user may frequently or always switch/change the UE 702 to a selfie mode (from a default mode) when taking pictures aligned with a road on a hike (e.g., a place full of soils and trees). In this case, during the training of the at least one use case learning AI/ML module 704, the at least one use case learning AI/ML module 704 may record this behavior and the probability of the selfie mode may increase with every such switch/change to the selfie mode until the training of the at least one use case learning AI/ML module 704 crosses a threshold of confidence. Then, as shown at 708, after the at least one use case learning AI/ML module 704 is trained (e.g., the training crosses the threshold of confidence), the at least one use case learning AI/ML module 704 may cause the UE 702 to switch/change into the selfie mode (e.g., switch to a front/screen-side camera) whenever the user's rear camera is pointing to a hiking trail (e.g., a soil road with trees). As such, under the reinforcement learning model, this probability may continue to be used to train the at least one use case learning AI/ML module 704 with every camera instance (e.g., every camera operation, every user input, etc.).

In another example, as shown at 710, the user may frequently or always switch/change the UE 702 to a panoramic photo mode (from a default mode) when taking pictures with a mountain range (e.g., a series of mountains or hills arranged in a line and connected by high ground). In this case, during the training of the at least one use case learning AI/ML module 704, the at least one use case learning AI/ML module 704 may record this behavior and the probability of the panoramic photo mode may increase with every such switch/change to the panoramic photo until the training of the at least one use case learning AI/ML module 704 crosses a threshold of confidence. Then, as shown at 712, after the at least one use case learning AI/ML module 704 is trained (e.g., the training crosses the threshold of confidence), the at least one use case learning AI/ML module 704 may cause the UE 702 to switch/change into the panoramic photo mode whenever the user's camera is pointing to a mountain range (or a mountain range like scenes).

In another example, the user may frequency or always trigger a single subject photo in portrait mode. In this case, the probability of the portrait mode may increase every time a single subject scene is captured in portrait mode (e.g., the portrait mode switch is triggered by the user for learning). Once the training probabilities for the at least one use case learning AI/ML module 704 appear confident (e.g., exceeds the confidence threshold), the triggering (of the portrait mode) may be made automatically by the UE 702 (or the at least one use case learning AI/ML module 704).

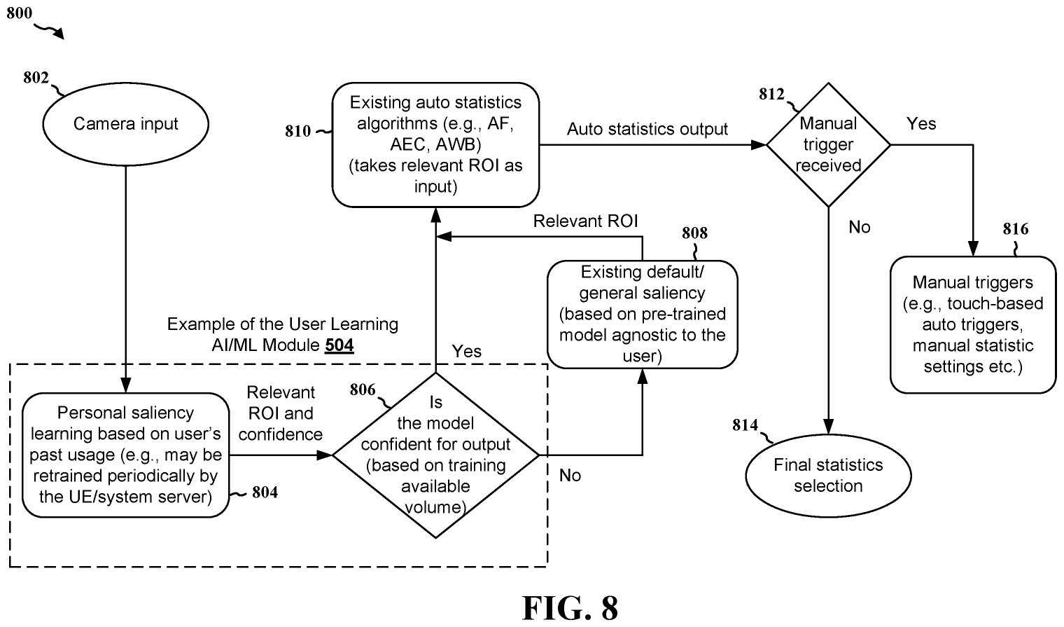

FIG. 8 is a flowchart 800 illustrating an example of a scene statistics selection based on the past usage of a user in accordance with various aspects of the present disclosure. The numberings associated with the flowchart 800 do not specify a particular temporal order and are merely used as references for the flowchart 800.

At 802, an AI/ML model (e.g., the at least one user learning AI/ML module 504) may receive an input from a camera (e.g., the UE 502), such as the FOV of the camera (e.g., after a user activates the camera and the camera is pointing towards one or more directions, etc.).

At 804, the AI/ML model may perform personal saliency learning/inferencing based on the user's past usage, such as described in connection with FIGS. 5 and 6. For example, based on the past images taken by the user, the AI/ML model may identify a set of relevant ROIs in the FOV of the camera and also a confidence level for the set of relevant ROIs. The confidence level may refer to how certain the AI/ML model is for an identified ROI (e.g., an object, a feature, a subject, etc.). For example, referring back to FIG. 6, after the user learning AI/ML module 504 identifies the Dalmatians in the FOV of the UE 502, the user learning AI/ML module 504 may also identify how confidence it is (e.g., a high level, a medium level, a low level, a quantified level, etc.).

At 806, the AI/ML model may determine whether the confidence level for the set of ROIs identified in the FOV of the camera reaches or exceeds a confidence threshold. If the confidence level reaches or exceeds the confidence threshold, the AI/ML model (or the camera) may output use the set of ROIs identified based on the user's past usage. On the other hand, if the confidence level does not reach or exceed the confidence threshold, as shown at 808, the AI/ML model (or the camera) may be configured to apply an existing default/general saliency (e.g., running a default AI/ML model such as a center weighted AI/ML model shown in FIG. 4) and identify ROIs in the FOV of the camera using the existing default/general saliency (e.g., not based on personal saliency).

At 810, based on the ROIs (obtained using a personal saliency or a default saliency), the AI/ML model (or the camera) may use these ROIs as input and automatically (auto) apply corresponding camera statistics to the FOV of the camera (or images captured by the camera). These camera statistics may be generated by auto statistics algorithms, which may include auto focusing (AF), auto exposure control (AEC), and/or auto white balancing (AWB), etc.

At 812, the AI/ML model (or the camera) may detect whether there is a manual trigger/input, such as whether the user is trying to manually adjust the focus, exposure, and/or white balancing of the camera. If the AI/ML model (or the camera) does not detect any manual trigger/input, as shown at 814, the AI/ML model (or the camera) may apply the camera statistics generated by auto statistics algorithms. On the other hand, if the AI/ML model (or the camera) detects a manual trigger/input, as shown at 816, the AI/ML model (or the camera) may apply the camera statistics manually input by the user.

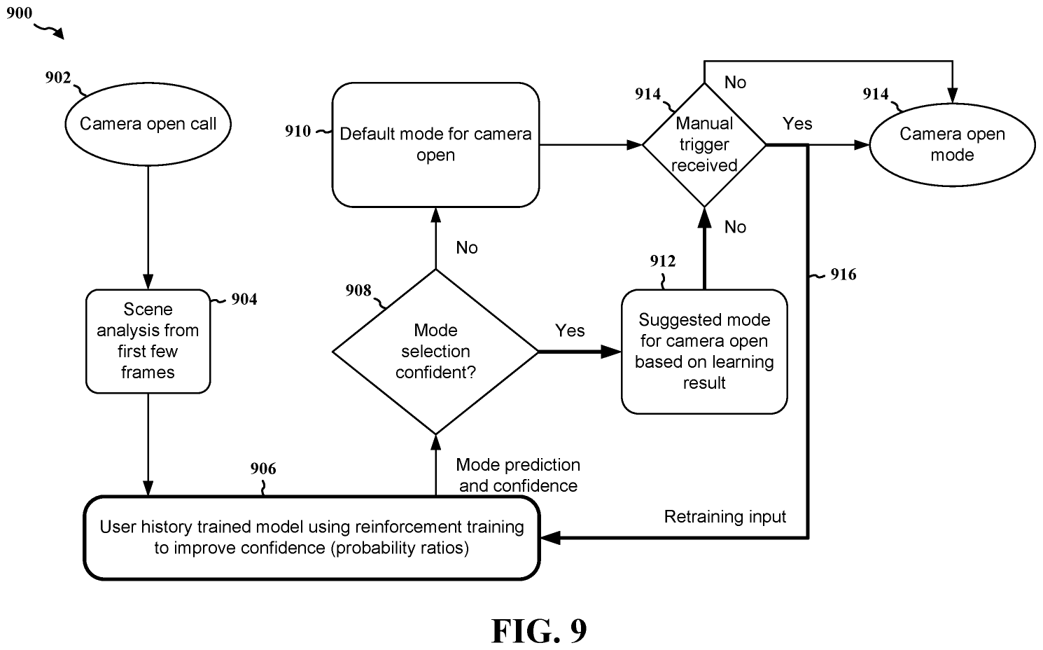

FIG. 9 is a flowchart 900 illustrating an example of a camera mode selection based on the past usage of a user in accordance with various aspects of the present disclosure. The numberings associated with the flowchart 900 do not specify a particular temporal order and are merely used as references for the flowchart 900.

At 902, an AI/ML model (e.g., the at least one use case learning AI/ML module 704) may receive an indication that a camera (e.g., the UE 702) is activated and is available for mode selection and triggering capture requests, which may be referred to a camera open call. For example, the user of the camera may have turned on the function by selecting a camera application.

At 904, after the camera is activated (e.g., the camera is capable of capturing images), the AI/ML model (or the camera) may analyze the scene captured by the camera (e.g., the scene within the FOV of the camera). For example, the AI/ML model (or the camera) may perform analysis for first few frames captured by the camera.

At 906, based on the scene analysis, the AI/ML model (or the camera) may select a suggested mode (e.g., a camera mode, such as a portrait mode, a selfie mode, a panoramic photo mode, a specified color/tone mode, etc.) to be applied to the camera based on the user's past usage, such as described in connection with FIG. 7. For example, the AI/ML model may be trained with the user's history usage based on reinforcement learning.

At 908, the AI/ML model (or the camera) may determine whether the selected mode has a confidence level exceeding a confidence threshold. If the confidence level for the suggested mode does not exceed the confidence threshold, as shown at 910, the AI/ML model (or the camera) may apply a default mode for the camera open. On the other hand, if the confidence level for the suggested mode meets or exceeds the confidence threshold, as shown at 912, the AI/ML model (or the camera) may output the suggested mode for camera open (e.g., based on the learning result).

At 914, the AI/ML model (or the camera) may detect whether there is a manual trigger/input, such as whether the user is trying to manually select a camera mode (e.g., a different camera mode) after either a default mode or the suggested mode is outputted (e.g., provided/shown to the user via camera). If the AI/ML model (or the camera) does not detect or receive any manual trigger/input, then the AI/ML model (or the camera) may apply either the default mode or the suggested mode for the camera open mode. On the other hand, if a manual trigger/input is received, as shown at 914, the AI/ML model (or the camera) may apply the mode manually input by the user for the camera open mode.

In some examples, as shown at 916, the manual trigger/input may further be used by the AI/ML model (or the camera) for training/retraining the AI/ML model (e.g., for performing the reinforcement training) to improve the confidence level (e.g., probability ratio) for the AI/ML model's mode selection.

Aspects described above may improve and enhance user experience in photography. As saliency is a subject aspect which is personal to a user and camera use cases, it is desirable to have a solution which can detect relevant objects in a scene based on personalized implementation of saliency. Aspects presented herein propose to include additional modules (over and above existing camera stats framework) to alter statistics selection based on output confidence. The module may be, for example, a deep learning (DL) model which learns statistics selection based on a user's past capture behaviors, and that data may be used to train a master DL model to select relevant objects in an FOV based on past usage of the user. Aspects presented herein may enable personalization of camera statistics selection algorithm based on each user and the user's tendencies/pattern in camera usage. For example, the camera may use a DL model that uses user's past captures (e.g., from online photos/cloud services/phone gallery, etc.) as a training base to extract relevant ROI in common FOVs, and act on top of the general saliency which may be part of a common/general implementation. Aspects presented herein may enable better image outputs with minimal to nil/zero user involvement. Aspects presented herein may use reinforcement learning on top of clustering and classification to learn which modes (e.g., camera mode) are most probable in any given camera use case.

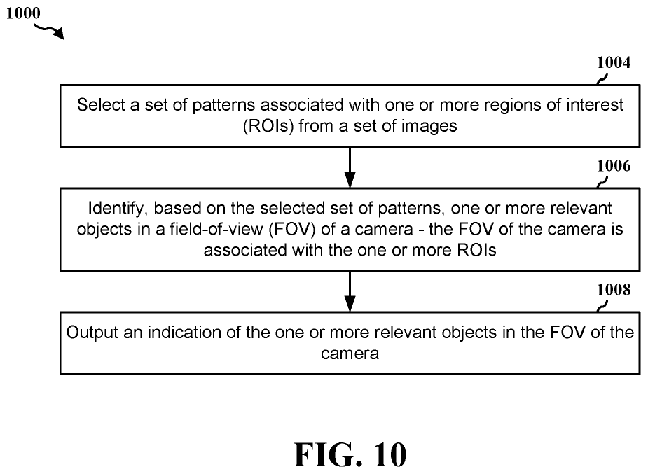

FIG. 10 is a flowchart 1000 of a method of wireless communication. The method may be performed by a UE (e.g., the UE 104, 402, 502, 702; the apparatus 1204). The method may enable the UE to use a user's past captures as a training base to extract relevant ROI in common FOVs to enable better image outputs with minimal user involvement.

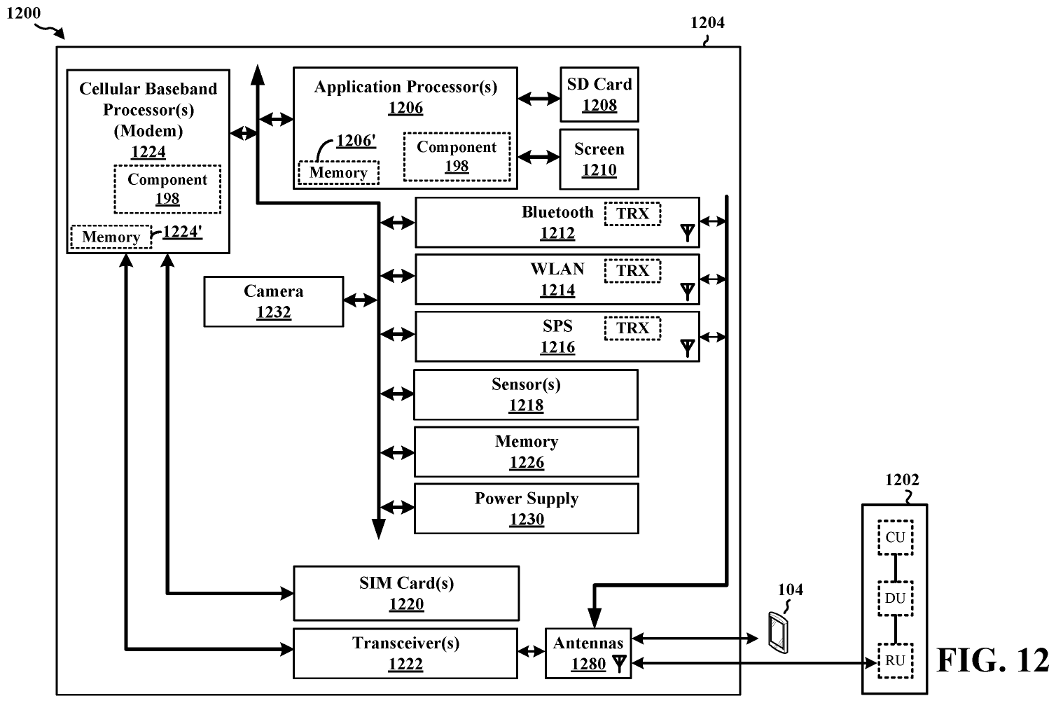

At 1004, the UE may select a set of patterns associated with one or more ROIs from a set of images, such as described in connection with FIGS. 5, 6, and 8. For example, as shown at 508 of FIG. 5, the UE 502 (or the user learning AI/ML module 504 associated with the UE 502) may selecting a set of patterns associated with one or more ROIs from images in a photo gallery. The selection of the set of patterns may be performed by, e.g., the past usage analysis component 198, the camera 1232, the transceiver(s) 1222, the cellular baseband processor(s) 1224, and/or the application processor(s) 1206 of the apparatus 1204 in FIG. 12.

In one example, the set of images may be a set of photographs or a set of frames associated with a video.

In another example, to select the set of patterns associated with the one or more ROIs from the set of images, the UE may cluster the set of images into a plurality of image groups based on at least one similarity between the plurality of image groups, evaluate each image group in the plurality of image groups for a set of image statistics or a set of image capturing behaviors, and train an AI/ML model to identify the one or more relevant objects in the FOV of the camera based on the set of image statistics or the set of image capturing behaviors. In some implementations, to identify the one or more relevant objects in the FOV of the camera, the UE may identify the one or more relevant objects in the FOV of the camera using the AI/ML model. In some implementations, the plurality of image groups may include: a first image group for at least one specified animal, a second image group for at least one specified person, a third image group for at least one specified outdoor environment, a fourth image group for at least one specified indoor environment, a fifth image group for at least one specified image subject, a sixth image group for at least one specified scenario, or a combination thereof. In some implementations, the UE may determine whether the AI/ML model is capable of identifying the one or more relevant objects in the FOV of the camera with a confidence level exceeding a confidence threshold, and the UE may deploy the AI/ML model for identifying the one or more relevant objects in the FOV of the camera if the AI/ML model has the confidence level exceeding the confidence threshold, or deploy an existing AI/ML model for identifying the one or more relevant objects in the FOV of the camera if the AI/ML model has the confidence level that does not exceed the confidence threshold.

At 1006, the UE may identify, based on the selected set of patterns, one or more relevant objects in an FOV of a camera, where the FOV of the camera may be associated with the one or more ROIs, such as described in connection with FIGS. 5, 6, and 8. For example, as shown at 602 of FIG. 6, the UE 502 (or the user learning AI/ML module 504 associated with the UE 502) may identify one or more relevant objects in the FOV of UE 502 based on the user's past usage behavior, where the FOV of the UE 502 may be associated with one or more ROIs as shown at 604. The identification of the one or more relevant objects may be performed by, e.g., the past usage analysis component 198, the camera 1232, the transceiver(s) 1222, the cellular baseband processor(s) 1224, and/or the application processor(s) 1206 of the apparatus 1204 in FIG. 12.

At 1008, the UE may output an indication of the one or more relevant objects in the FOV of the camera, such as described in connection with FIGS. 5, 6, and 8. For example, as shown at 602 of FIG. 6, the UE 502 (or the user learning AI/ML module 504 associated with the UE 502) may output an indication of the one or more relevant objects in the FOV of UE 502, such as by displaying bounding boxes around the one or more relevant objects as shown at 604. The output of the indication may be performed by, e.g., the past usage analysis component 198, the camera 1232, the transceiver(s) 1222, the cellular baseband processor(s) 1224, and/or the application processor(s) 1206 of the apparatus 1204 in FIG. 12.

In one example, to output the indication of the one or more relevant objects in the FOV of the camera, the UE may consume the indication of the one or more relevant objects in the FOV of the camera, store the indication of the one or more relevant objects in the FOV of the camera, or transmit the indication of the one or more relevant objects in the FOV of the camera.

In another example, the UE may select the one or more ROIs from the set of images, where the selection of the set of patterns is based on the selection of the one or more ROIs, such as described in connection with FIGS. 5, 6, and 8. For example, as shown by FIG. 5, the UE 502 m select one or more objects or their associated ROIs from images in the photo gallery, where the selected objects/ROIs may be used for selecting the set of patterns. The selection of the one or more ROIs from the set of images may be performed by, e.g., the past usage analysis component 198, the camera 1232, the transceiver(s) 1222, the cellular baseband processor(s) 1224, and/or the application processor(s) 1206 of the apparatus 1204 in FIG. 12.

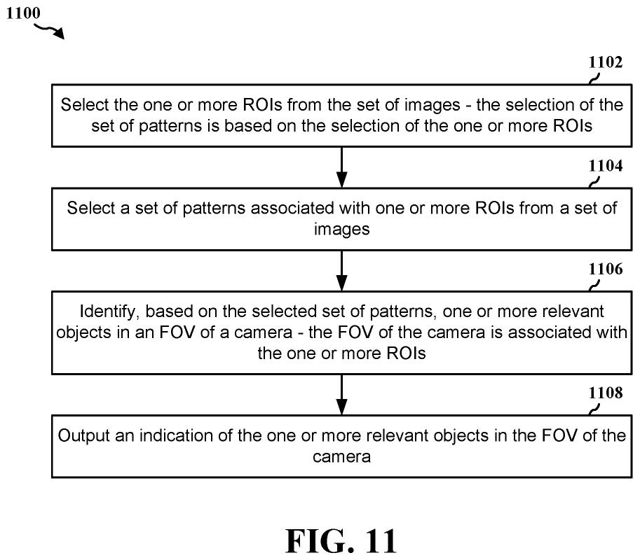

FIG. 11 is a flowchart 1100 of a method of wireless communication. The method may be performed by a UE (e.g., the UE 104, 402, 502, 702; the apparatus 1204). The method may enable the UE to use a user's past captures as a training base to extract relevant ROI in common FOVs to enable better image outputs with minimal user involvement.

At 1104, the UE may select a set of patterns associated with one or more ROIs from a set of images, such as described in connection with FIGS. 5, 6, and 8. For example, as shown at 508 of FIG. 5, the UE 502 (or the user learning AI/ML module 504 associated with the UE 502) may selecting a set of patterns associated with one or more ROIs from images in a photo gallery. The selection of the set of patterns may be performed by, e.g., the past usage analysis component 198, the camera 1232, the transceiver(s) 1222, the cellular baseband processor(s) 1224, and/or the application processor(s) 1206 of the apparatus 1204 in FIG. 12.

In one example, the set of images may be a set of photographs or a set of frames associated with a video.

In another example, to select the set of patterns associated with the one or more ROIs from the set of images, the UE may cluster the set of images into a plurality of image groups based on at least one similarity between the plurality of image groups, evaluate each image group in the plurality of image groups for a set of image statistics or a set of image capturing behaviors, and train an AI/ML model to identify the one or more relevant objects in the FOV of the camera based on the set of image statistics or the set of image capturing behaviors. In some implementations, to identify the one or more relevant objects in the FOV of the camera, the UE may identify the one or more relevant objects in the FOV of the camera using the AI/ML model. In some implementations, the plurality of image groups may include: a first image group for at least one specified animal, a second image group for at least one specified person, a third image group for at least one specified outdoor environment, a fourth image group for at least one specified indoor environment, a fifth image group for at least one specified image subject, a sixth image group for at least one specified scenario, or a combination thereof. In some implementations, the UE may determine whether the AI/ML model is capable of identifying the one or more relevant objects in the FOV of the camera with a confidence level exceeding a confidence threshold, and the UE may deploy the AI/ML model for identifying the one or more relevant objects in the FOV of the camera if the AI/ML model has the confidence level exceeding the confidence threshold, or deploy an existing AI/ML model for identifying the one or more relevant objects in the FOV of the camera if the AI/ML model has the confidence level that does not exceed the confidence threshold.

At 1106, the UE may identify, based on the selected set of patterns, one or more relevant objects in an FOV of a camera, where the FOV of the camera may be associated with the one or more ROIs, such as described in connection with FIGS. 5, 6, and 8. For example, as shown at 602 of FIG. 6, the UE 502 (or the user learning AI/ML module 504 associated with the UE 502) may identify one or more relevant objects in the FOV of UE 502 based on the user's past usage behavior, where the FOV of the UE 502 may be associated with one or more ROIs as shown at 604. The identification of the one or more relevant objects may be performed by, e.g., the past usage analysis component 198, the camera 1232, the transceiver(s) 1222, the cellular baseband processor(s) 1224, and/or the application processor(s) 1206 of the apparatus 1204 in FIG. 12.

At 1108, the UE may output an indication of the one or more relevant objects in the FOV of the camera, such as described in connection with FIGS. 5, 6, and 8. For example, as shown at 602 of FIG. 6, the UE 502 (or the user learning AI/ML module 504 associated with the UE 502) may output an indication of the one or more relevant objects in the FOV of UE 502, such as by displaying bounding boxes around the one or more relevant objects as shown at 604. The output of the indication may be performed by, e.g., the past usage analysis component 198, the camera 1232, the transceiver(s) 1222, the cellular baseband processor(s) 1224, and/or the application processor(s) 1206 of the apparatus 1204 in FIG. 12.

In one example, to output the indication of the one or more relevant objects in the FOV of the camera, the UE may consume the indication of the one or more relevant objects in the FOV of the camera, store the indication of the one or more relevant objects in the FOV of the camera, or transmit the indication of the one or more relevant objects in the FOV of the camera.

In another example, as shown at 1102, the UE may select the one or more ROIs from the set of images, where the selection of the set of patterns is based on the selection of the one or more ROIs, such as described in connection with FIGS. 5, 6, and 8. For example, as shown by FIG. 5, the UE 502 m select one or more objects or their associated ROIs from images in the photo gallery, where the selected objects/ROIs may be used for selecting the set of patterns. The selection of the one or more ROIs from the set of images may be performed by, e.g., the past usage analysis component 198, the camera 1232, the transceiver(s) 1222, the cellular baseband processor(s) 1224, and/or the application processor(s) 1206 of the apparatus 1204 in FIG. 12.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; ultrawide band (UWB) sensor, motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., sec UE 350 of FIG. 3) and include the additional modules of the apparatus 1204.

As discussed supra, the past usage analysis component 198 may be configured to select a set of patterns associated with one or more ROIs from a set of images. The past usage analysis component 198 may also be configured to identify, based on the selected set of patterns, one or more relevant objects in an FOV of a camera, where the FOV of the camera is associated with the one or more ROIs. The past usage analysis component 198 may also be configured to output an indication of the one or more relevant objects in the FOV of the camera. The past usage analysis component 198 may be within the cellular baseband processor(s) 1224, the application processor(s) 1206, or both the cellular baseband processor(s) 1224 and the application processor(s) 1206. The past usage analysis component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for selecting a set of patterns associated with one or more ROIs from a set of images. The apparatus 1204 may further include means for identifying, based on the selected set of patterns, one or more relevant objects in an FOV of a camera, where the FOV of the camera is associated with the one or more ROIs. The apparatus 1204 may further include means for outputting an indication of the one or more relevant objects in the FOV of the camera.

In one configuration, the set of images may be a set of photographs or a set of frames associated with a video.

In another configuration, the means for selecting the set of patterns associated with the one or more ROIs from the set of images may include configuring the apparatus 1204 to cluster the set of images into a plurality of image groups based on at least one similarity between the plurality of image groups, evaluate each image group in the plurality of image groups for a set of image statistics or a set of image capturing behaviors, and train an AI/ML model to identify the one or more relevant objects in the FOV of the camera based on the set of image statistics or the set of image capturing behaviors. In some implementations, to identify the one or more relevant objects in the FOV of the camera, the apparatus 1204 may identify the one or more relevant objects in the FOV of the camera using the AI/ML model. In some implementations, the plurality of image groups may include: a first image group for at least one specified animal, a second image group for at least one specified person, a third image group for at least one specified outdoor environment, a fourth image group for at least one specified indoor environment, a fifth image group for at least one specified image subject, a sixth image group for at least one specified scenario, or a combination thereof. In some implementations, the apparatus 1204 may further include means for determining whether the AI/ML model is capable of identifying the one or more relevant objects in the FOV of the camera with a confidence level exceeding a confidence threshold, and means for deploying the AI/ML model for identifying the one or more relevant objects in the FOV of the camera if the AI/ML model has the confidence level exceeding the confidence threshold, or means for deploying an existing AI/ML model for identifying the one or more relevant objects in the FOV of the camera if the AI/ML model has the confidence level that does not exceed the confidence threshold.

In another configuration, the means for outputting the indication of the one or more relevant objects in the FOV of the camera may include configuring the apparatus 1204 to consume the indication of the one or more relevant objects in the FOV of the camera, store the indication of the one or more relevant objects in the FOV of the camera, or transmit the indication of the one or more relevant objects in the FOV of the camera.

In another configuration, the apparatus 1204 may further include means for selecting the one or more ROIs from the set of images, where the selection of the set of patterns is based on the selection of the one or more ROIs.

The means may be the past usage analysis component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

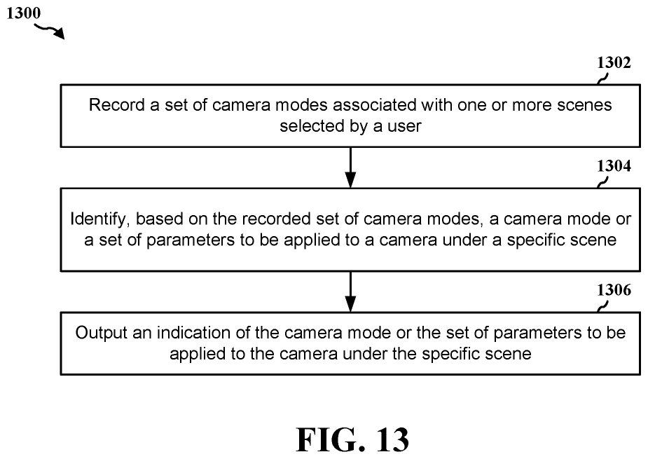

FIG. 13 is a flowchart 1300 of a method of wireless communication. The method may be performed by a UE (e.g., the UE 104, 402, 502, 702; the apparatus 1404). The method may enable the UE to use a user's past captures as a training base to select a camera mode for the user to enable better user experience in photography with minimal user involvement.

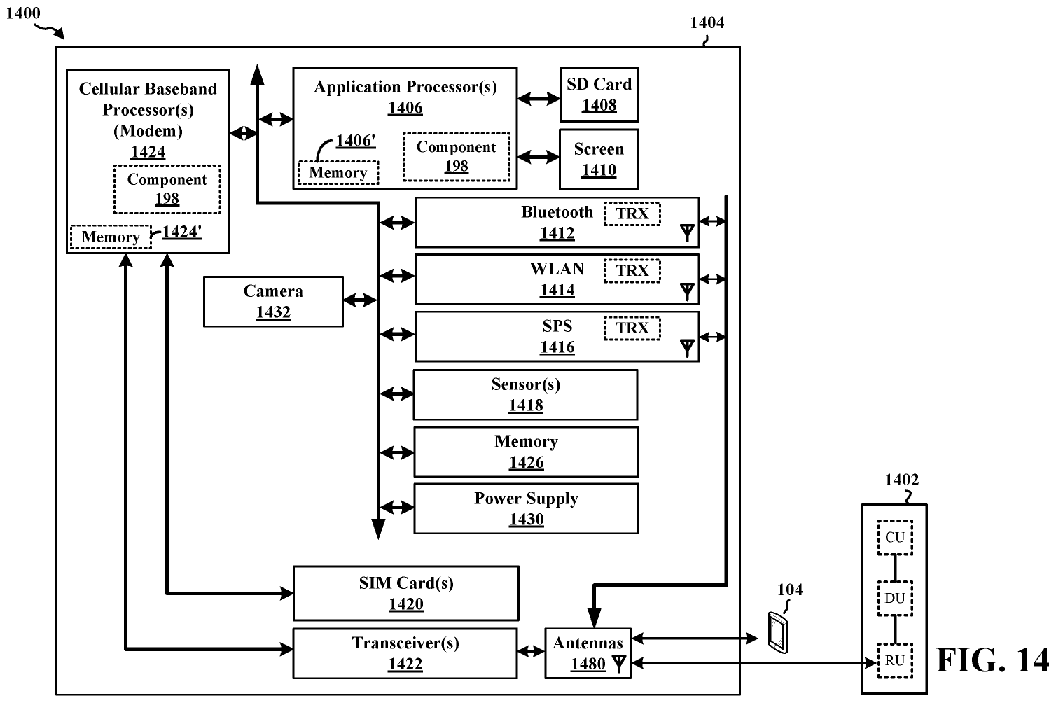

At 1302, the UE may record a set of camera modes associated with one or more scenes selected by a user, such as described in connection with FIGS. 7 and 9. For example, as shown at 706 of FIG. 7, a user may frequently or always switch/change the UE 702 to a selfie mode (from a default mode) when taking pictures aligned with a road on a hike (e.g., a place full of soils and trees). In this case, during the training of the at least one use case learning AI/ML module 704, the at least one use case learning AI/ML module 704 may record this behavior and the probability of the selfie mode may increase with every such switch/change to the selfie mode until the training of the at least one use case learning AI/ML module 704 crosses a threshold of confidence. The recordation of the set of camera modes may be performed by, e.g., the past usage analysis component 198, the camera 1432, the transceiver(s) 1422, the cellular baseband processor(s) 1424, and/or the application processor(s) 1406 of the apparatus 1404 in FIG. 14.

In one example, to record the set of camera modes associated with the one or more scenes performed by the user, the UE may cluster the one or more scenes into a plurality of scene groups based on at least one similarity between the plurality of scene groups, evaluate each scene group in the plurality of scene groups for a set of mode selection statistics or a set of image capturing behaviors, and train an AI/ML model to identify the camera mode or the set of parameters to be applied to the camera under the specific scene based on the set of mode selection statistics or the set of image capturing behaviors. In some implementations, to identify the camera mode or the set of parameters to be applied to the camera under the specific scene, the UE may identify the camera mode or the set of parameters to be applied to the camera under the specific scene using the AI/ML model. In some implementations, the plurality of scene groups may include a first scene group for at least one specified event, a second scene group for at least one specified landscape, a third scene group for at least one specified outdoor activity, or a combination thereof. In some implementations, the UE may determine whether the AI/ML model is capable of identifying the camera mode or the set of parameters to be applied to the camera under the specific scene with a confidence level exceeding a confidence threshold, and deploy the AI/ML model for identifying the camera mode or the set of parameters to be applied to the camera under the specific scene if the AI/ML model has the confidence level exceeding the confidence threshold, or deploy an existing AI/ML model for identifying the camera mode or the set of parameters to be applied to the camera under the specific scene if the AI/ML model has the confidence level that does not exceed the confidence threshold. In some implementations, the AI/ML model may be associated with a reinforcement learning model. In some implementations, the identified camera mode or the identified set of parameters may correspond to a highest probability among the set of camera modes.

At 1304, the UE may identify, based on the recorded set of camera modes, a camera mode or a set of parameters to be applied to a camera under a specific scene, such as described in connection with FIGS. 7 and 9. For example, as shown at 708 of FIG. 7, after the at least one use case learning AI/ML module 704 is trained (e.g., the training crosses the threshold of confidence), the at least one use case learning AI/ML module 704 may cause the UE 702 to switch/change into the selfie mode (e.g., switch to a front/screen-side camera) whenever the user's rear camera is pointing to a hiking trail (e.g., a soil road with trees). The identification of the camera mode or the set of parameters to be applied may be performed by, e.g., the past usage analysis component 198, the camera 1432, the transceiver(s) 1422, the cellular baseband processor(s) 1424, and/or the application processor(s) 1406 of the apparatus 1404 in FIG. 14.

At 1306, the UE may output an indication of the camera mode or the set of parameters to be applied to the camera under the specific scene, such as described in connection with FIGS. 7 and 9. For example, as shown at 708 of FIG. 7, the at least one use case learning AI/ML module 704 may cause the UE 702 to switch/change into the selfie mode whenever the user's rear camera is pointing to a hiking trail. The output of the indication may be performed by, e.g., the past usage analysis component 198, the camera 1432, the transceiver(s) 1422, the cellular baseband processor(s) 1424, and/or the application processor(s) 1406 of the apparatus 1404 in FIG. 14.

In one example, to output the indication, the UE may consume the indication of the camera mode or the set of parameters, store the indication of the camera mode or the set of parameters, or transmit the indication of the camera mode or the set of parameters.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; ultrawide band (UWB) sensor, motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., sec UE 350 of FIG. 3) and include the additional modules of the apparatus 1404.

As discussed supra, the past usage analysis component 198 may be configured to record a set of camera modes associated with one or more scenes selected by a user. The past usage analysis component 198 may also be configured to identify, based on the recorded set of camera modes, a camera mode or a set of parameters to be applied to a camera under a specific scene. The past usage analysis component 198 may also be configured to output an indication of the camera mode or the set of parameters to be applied to the camera under the specific scene. The past usage analysis component 198 may be within the cellular baseband processor(s) 1424, the application processor(s) 1406, or both the cellular baseband processor(s) 1424 and the application processor(s) 1406. The past usage analysis component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for recording a set of camera modes associated with one or more scenes selected by a user. The apparatus 1404 may further include means for identifying, based on the recorded set of camera modes, a camera mode or a set of parameters to be applied to a camera under a specific scene. The apparatus 1404 may further include means for outputting an indication of the camera mode or the set of parameters to be applied to the camera under the specific scene.

In one configuration, the means for recording the set of camera modes associated with the one or more scenes performed by the user may include configuring the apparatus 1404 to cluster the one or more scenes into a plurality of scene groups based on at least one similarity between the plurality of scene groups, evaluate each scene group in the plurality of scene groups for a set of mode selection statistics or a set of image capturing behaviors, and train an AI/ML model to identify the camera mode or the set of parameters to be applied to the camera under the specific scene based on the set of mode selection statistics or the set of image capturing behaviors. In some implementations, to identify the camera mode or the set of parameters to be applied to the camera under the specific scene, the apparatus 1404 may be configured to identify the camera mode or the set of parameters to be applied to the camera under the specific scene using the AI/ML model. In some implementations, the plurality of scene groups may include a first scene group for at least one specified event, a second scene group for at least one specified landscape, a third scene group for at least one specified outdoor activity, or a combination thereof. In some implementations, the apparatus 1404 may further include means for determining whether the AI/ML model is capable of identifying the camera mode or the set of parameters to be applied to the camera under the specific scene with a confidence level exceeding a confidence threshold, and means for deploying the AI/ML model for identifying the camera mode or the set of parameters to be applied to the camera under the specific scene if the AI/ML model has the confidence level exceeding the confidence threshold, or means for deploying an existing AI/ML model for identifying the camera mode or the set of parameters to be applied to the camera under the specific scene if the AI/ML model has the confidence level that does not exceed the confidence threshold. In some implementations, the AI/ML model may be associated with a reinforcement learning model. In some implementations, the identified camera mode or the identified set of parameters may correspond to a highest probability among the set of camera modes.

In another configuration, the means for outputting the indication may include configuring the apparatus 1404 to consume the indication of the camera mode or the set of parameters, store the indication of the camera mode or the set of parameters, or transmit the indication of the camera mode or the set of parameters.

The means may be the past usage analysis component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of processing image data, comprising: selecting a set of patterns associated with one or more regions of interest (ROIs) from a set of images; identifying, based on the selected set of patterns, one or more relevant objects in a field of view (FOV) of a camera, wherein the FOV of the camera is associated with the one or more ROIs; and outputting an indication of the one or more relevant objects in the FOV of the camera.

Aspect 2 is the method of aspect 1, wherein outputting the indication of the one or more relevant objects in the FOV of the camera comprises: consuming the indication of the one or more relevant objects in the FOV of the camera; storing the indication of the one or more relevant objects in the FOV of the camera; or transmitting the indication of the one or more relevant objects in the FOV of the camera.

Aspect 3 is the method of aspect 1 or aspect 2, further comprising: selecting the one or more ROIs from the set of images, wherein the selection of the set of patterns is based on the selection of the one or more ROIs.

Aspect 4 is the method of any of aspects 1 to 3, wherein the set of images is a set of photographs or a set of frames associated with a video.

Aspect 5 is the method of any of aspects 1 to 4, wherein selecting the set of patterns associated with the one or more ROIs from the set of images comprises: clustering the set of images into a plurality of image groups based on at least one similarity between the plurality of image groups; evaluating each image group in the plurality of image groups for a set of image statistics or a set of image capturing behaviors; and training an artificial intelligence (AI) or machine learning (ML) (AI/ML) model to identify the one or more relevant objects in the FOV of the camera based on the set of image statistics or the set of image capturing behaviors.

Aspect 6 is the method of any of aspects 1 to 5, wherein identifying the one or more relevant objects in the FOV of the camera comprises: identifying the one or more relevant objects in the FOV of the camera using the AI/ML model.

Aspect 7 is the method of any of aspects 1 to 6, wherein the plurality of image groups includes: a first image group for at least one specified animal, a second image group for at least one specified person, a third image group for at least one specified outdoor environment, a fourth image group for at least one specified indoor environment, a fifth image group for at least one specified image subject, a sixth image group for at least one specified scenario, or a combination thereof.

Aspect 8 is the method of any of aspects 1 to 7, further comprising: determining whether the AI/ML model is capable of identifying the one or more relevant objects in the FOV of the camera with a confidence level exceeding a confidence threshold; and deploying the AI/ML model for identifying the one or more relevant objects in the FOV of the camera if the AI/ML model has the confidence level exceeding the confidence threshold, or deploying an existing AI/ML model for identifying the one or more relevant objects in the FOV of the camera if the AI/ML model has the confidence level that does not exceed the confidence threshold.

Aspect 9 is the method of any of aspects 1 to 8, further comprising: storing the set of images on a storage associated with the camera or on a cloud server.

Aspect 10 is an apparatus for processing image data, including: at least one memory; and at least one processor coupled to the at least one memory and, based at least in part on information stored in the at least one memory, the at least one processor, individually or in any combination, is configured to implement any of aspects 1 to 9.

Aspect 11 is the apparatus of aspect 10, further comprising at least one of a transceiver or an antenna coupled to the at least one processor, wherein to output the indication, the at least one processor, individually or in any combination, is configured to: output, via at least one of the transceiver or the antenna, the indication.

Aspect 12 is an apparatus for processing image data including means for implementing any of aspects 1 to 9.

Aspect 13 is a computer-readable medium (e.g., a non-transitory computer-readable medium) storing computer executable code, where the code when executed by a processor causes the processor to implement any of aspects 1 to 9.

Aspect 14 is a method of processing image data, comprising: recording a set of camera modes associated with one or more scenes selected by a user; identifying, based on the recorded set of camera modes, a camera mode or a set of parameters to be applied to a camera under a specific scene; and outputting an indication of the camera mode or the set of parameters to be applied to the camera under the specific scene.

Aspect 15 is the method of aspect 14, wherein outputting the indication comprises: consuming the indication of the camera mode or the set of parameters; storing the indication of the camera mode or the set of parameters; or transmitting the indication of the camera mode or the set of parameters.

Aspect 16 is the method of aspect 14 or aspect 15, wherein recording the set of camera modes associated with the one or more scenes performed by the user comprises: clustering the one or more scenes into a plurality of scene groups based on at least one similarity between the plurality of scene groups; evaluating each scene group in the plurality of scene groups for a set of mode selection statistics or a set of image capturing behaviors; and training an artificial intelligence (AI) or machine learning (ML) (AI/ML) model to identify the camera mode or the set of parameters to be applied to the camera under the specific scene based on the set of mode selection statistics or the set of image capturing behaviors.

Aspect 17 is the method of any of aspects 14 to 16, wherein identifying the camera mode or the set of parameters to be applied to the camera under the specific scene comprises: identifying the camera mode or the set of parameters to be applied to the camera under the specific scene using the AI/ML model.

Aspect 18 is the method of any of aspects 14 to 17, wherein the plurality of scene groups includes: a first scene group for at least one specified event, a second scene group for at least one specified landscape, a third scene group for at least one specified outdoor activity, or a combination thereof.

Aspect 19 is the method of any of aspects 14 to 18, further comprising: determining whether the AI/ML model is capable of identifying the camera mode or the set of parameters to be applied to the camera under the specific scene with a confidence level exceeding a confidence threshold; and deploying the AI/ML model for identifying the camera mode or the set of parameters to be applied to the camera under the specific scene if the AI/ML model has the confidence level exceeding the confidence threshold, or deploying an existing AI/ML model for identifying the camera mode or the set of parameters to be applied to the camera under the specific scene if the AI/ML model has the confidence level that does not exceed the confidence threshold.

Aspect 20 is the method of any of aspects 14 to 19, wherein the AI/ML model is associated with a reinforcement learning model.

Aspect 21 is the method of any of aspects 14 to 20, wherein the identified camera mode or the identified set of parameters corresponds to a highest probability among the set of camera modes.

Aspect 22 is an apparatus for processing image data, including: at least one memory; and at least one processor coupled to the at least one memory and, based at least in part on information stored in the at least one memory, the at least one processor, individually or in any combination, is configured to implement any of aspects 14 to 21.

Aspect 23 is the apparatus of aspect 22, further comprising at least one of a transceiver or an antenna coupled to the at least one processor, wherein to output the indication, the at least one processor, individually or in any combination, is configured to: output, via at least one of the transceiver or the antenna, the indication.

Aspect 24 is an apparatus for processing image data including means for implementing any of aspects 14 to 21.

Aspect 25 is a computer-readable medium (e.g., a non-transitory computer-readable medium) storing computer executable code, where the code when executed by a processor causes the processor to implement any of aspects 14 to 21.

What is claimed is:

1. An apparatus for processing image data, comprising:
at least one memory; and
at least one processor coupled to the at least one memory and, based at least in part on information stored in the at least one memory, the at least one processor, individually or in any combination, is configured to:
select a set of patterns associated with one or more regions of interest (ROIs) from a set of images;
identify, based on the selected set of patterns, one or more relevant objects in a field of view (FOV) of a camera, wherein the FOV of the camera is associated with the one or more ROIs; and
output an indication of the one or more relevant objects in the FOV of the camera.

2. The apparatus of claim 1, wherein to output the indication of the one or more relevant objects in the FOV of the camera, the at least one processor, individually or in any combination, is configured to:
consume the indication of the one or more relevant objects in the FOV of the camera;
store the indication of the one or more relevant objects in the FOV of the camera; or
transmit the indication of the one or more relevant objects in the FOV of the camera.

3. The apparatus of claim 1, wherein the at least one processor, individually or in any combination, is further configured to:
select the one or more ROIs from the set of images, wherein the selection of the set of patterns is based on the selection of the one or more ROIs.

4. The apparatus of claim 1, wherein the set of images is a set of photographs or a set of frames associated with a video.

5. The apparatus of claim 1, wherein to select the set of patterns associated with the one or more ROIs from the set of images, the at least one processor, individually or in any combination, is configured to:
cluster the set of images into a plurality of image groups based on at least one similarity between the plurality of image groups;
evaluate each image group in the plurality of image groups for a set of image statistics or a set of image capturing behaviors; and
train an artificial intelligence (AI) or machine learning (ML) (AI/ML) model to identify the one or more relevant objects in the FOV of the camera based on the set of image statistics or the set of image capturing behaviors.

6. The apparatus of claim 5, wherein to identify the one or more relevant objects in the FOV of the camera, the at least one processor, individually or in any combination, is configured to:
identify the one or more relevant objects in the FOV of the camera using the AI/ML model.

7. The apparatus of claim 5, wherein the plurality of image groups includes:
a first image group for at least one specified animal,
a second image group for at least one specified person,
a third image group for at least one specified outdoor environment,
a fourth image group for at least one specified indoor environment,
a fifth image group for at least one specified image subject,
a sixth image group for at least one specified scenario, or
a combination thereof.

8. The apparatus of claim 5, wherein the at least one processor, individually or in any combination, is further configured to:
determine whether the AI/ML model is capable of identifying the one or more relevant objects in the FOV of the camera with a confidence level exceeding a confidence threshold; and
deploy the AI/ML model for identifying the one or more relevant objects in the FOV of the camera if the AI/ML model has the confidence level exceeding the confidence threshold, or deploy an existing AI/ML model for identifying the one or more relevant objects in the FOV of the camera if the AI/ML model has the confidence level that does not exceed the confidence threshold.

9. The apparatus of claim 1, wherein the at least one processor, individually or in any combination, is further configured to:
store the set of images on a storage associated with the camera or on a cloud server.

10. The apparatus of claim 1, further comprising at least one of a transceiver or an antenna coupled to the at least one processor, wherein to output the indication, the at least one processor, individually or in any combination, is configured to: output, via at least one of the transceiver or the antenna, the indication.

11. A method of processing image data, comprising:
selecting a set of patterns associated with one or more regions of interest (ROIs) from a set of images;
identifying, based on the selected set of patterns, one or more relevant objects in a field of view (FOV) of a camera, wherein the FOV of the camera is associated with the one or more ROIs; and
outputting an indication of the one or more relevant objects in the FOV of the camera.

12. The method of claim 11, wherein outputting the indication of the one or more relevant objects in the FOV of the camera comprises:
consuming the indication of the one or more relevant objects in the FOV of the camera;
storing the indication of the one or more relevant objects in the FOV of the camera; or
transmitting the indication of the one or more relevant objects in the FOV of the camera.

13. The method of claim 11, further comprising:
selecting the one or more ROIs from the set of images, wherein the selection of the set of patterns is based on the selection of the one or more ROIs.

14. The method of claim 11, wherein selecting the set of patterns associated with the one or more ROIs from the set of images comprises:
clustering the set of images into a plurality of image groups based on at least one similarity between the plurality of image groups;
evaluating each image group in the plurality of image groups for a set of image statistics or a set of image capturing behaviors; and
training an artificial intelligence (AI) or machine learning (ML) (AI/ML) model to identify the one or more relevant objects in the FOV of the camera based on the set of image statistics or the set of image capturing behaviors.

15. The method of claim 14, further comprising:
determining whether the AI/ML model is capable of identifying the one or more relevant objects in the FOV of the camera with a confidence level exceeding a confidence threshold; and
deploying the AI/ML model for identifying the one or more relevant objects in the FOV of the camera if the AI/ML model has the confidence level exceeding the confidence threshold, or deploying an existing AI/ML model for identifying the one or more relevant objects in the FOV of the camera if the AI/ML model has the confidence level that does not exceed the confidence threshold.

16. An apparatus for processing image data, comprising:
at least one memory; and
at least one processor coupled to the at least one memory and, based at least in part on information stored in the at least one memory, the at least one processor, individually or in any combination, is configured to:
record a set of camera modes associated with one or more scenes selected by a user;
identify, based on the recorded set of camera modes, a camera mode or a set of parameters to be applied to a camera under a specific scene; and
output an indication of the camera mode or the set of parameters to be applied to the camera under the specific scene.

17. The apparatus of claim 16, wherein to output the indication, the at least one processor, individually or in any combination, is configured to:
consume the indication of the camera mode or the set of parameters;
store the indication of the camera mode or the set of parameters; or
transmit the indication of the camera mode or the set of parameters.

18. The apparatus of claim 16, wherein to record the set of camera modes associated with the one or more scenes performed by the user, the at least one processor, individually or in any combination, is configured to:
cluster the one or more scenes into a plurality of scene groups based on at least one similarity between the plurality of scene groups;
evaluate each scene group in the plurality of scene groups for a set of mode selection statistics or a set of image capturing behaviors; and
train an artificial intelligence (AI) or machine learning (ML) (AI/ML) model to identify the camera mode or the set of parameters to be applied to the camera under the specific scene based on the set of mode selection statistics or the set of image capturing behaviors.

19. The apparatus of claim 18, wherein to identify the camera mode or the set of parameters to be applied to the camera under the specific scene, the at least one processor, individually or in any combination, is configured to:
identify the camera mode or the set of parameters to be applied to the camera under the specific scene using the AI/ML model.

20. The apparatus of claim 18, wherein the plurality of scene groups includes:
a first scene group for at least one specified event,
a second scene group for at least one specified landscape,
a third scene group for at least one specified outdoor activity, or
a combination thereof.

21. The apparatus of claim 18, wherein the at least one processor, individually or in any combination, is further configured to:
determine whether the AI/ML model is capable of identifying the camera mode or the set of parameters to be applied to the camera under the specific scene with a confidence level exceeding a confidence threshold; and
deploy the AI/ML model for identifying the camera mode or the set of parameters to be applied to the camera under the specific scene if the AI/ML model has the confidence level exceeding the confidence threshold, or deploy an existing AI/ML model for identifying the camera mode or the set of parameters to be applied to the camera under the specific scene if the AI/ML model has the confidence level that does not exceed the confidence threshold.

22. The apparatus of claim 18, wherein the AI/ML model is associated with a reinforcement learning model.

23. The apparatus of claim 18, wherein the identified camera mode or the identified set of parameters corresponds to a highest probability among the set of camera modes.

24. The apparatus of claim 16, further comprising at least one of a transceiver or an antenna coupled to the at least one processor, wherein to output the indication, the at least one processor, individually or in any combination, is configured to: output, via at least one of the transceiver or the antenna, the indication.

25. A method of processing image data, comprising:
recording a set of camera modes associated with one or more scenes selected by a user;
identifying, based on the recorded set of camera modes, a camera mode or a set of parameters to be applied to a camera under a specific scene; and
outputting an indication of the camera mode or the set of parameters to be applied to the camera under the specific scene.

26. The method of claim 25, wherein outputting the indication comprises:
consuming the indication of the camera mode or the set of parameters;
storing the indication of the camera mode or the set of parameters; or
transmitting the indication of the camera mode or the set of parameters.

27. The method of claim 25, wherein recording the set of camera modes associated with the one or more scenes performed by the user comprises:
clustering the one or more scenes into a plurality of scene groups based on at least one similarity between the plurality of scene groups;
evaluating each scene group in the plurality of scene groups for a set of mode selection statistics or a set of image capturing behaviors; and
training an artificial intelligence (AI) or machine learning (ML) (AI/ML) model to identify the camera mode or the set of parameters to be applied to the camera under the specific scene based on the set of mode selection statistics or the set of image capturing behaviors.

28. The method of claim 27, wherein identifying the camera mode or the set of parameters to be applied to the camera under the specific scene comprises:
identifying the camera mode or the set of parameters to be applied to the camera under the specific scene using the AI/ML model.

29. The method of claim 27, wherein the plurality of scene groups includes:
a first scene group for at least one specified event,
a second scene group for at least one specified landscape,
a third scene group for at least one specified outdoor activity, or
a combination thereof.

30. The method of claim 27, further comprising:
determining whether the AI/ML model is capable of identifying the camera mode or the set of parameters to be applied to the camera under the specific scene with a confidence level exceeding a confidence threshold; and
deploying the AI/ML model for identifying the camera mode or the set of parameters to be applied to the camera under the specific scene if the AI/ML model has the confidence level exceeding the confidence threshold, or deploying an existing AI/ML model for identifying the camera mode or the set of parameters to be applied to the camera under the specific scene if the AI/ML model has the confidence level that does not exceed the confidence threshold.
